(19) United States
(12) Patent Application Publication
(10) Pub. No.: US 2003/0102952 A1
(43) Pub. Date: Jun. 5, 2003

(54) Variable power transformer of any voltage supply steady current intensity and absolute accuracy

(76) Inventor: Panayotis Theofylaktos, Athens (GR)

Correspondence Address: Dipl Ing V Mantzikas, 68 Solonos Street, Athens, 106 80, GR

(21) Appl. No.: 09/936,129

(22) PCT Filed: Jan. 12, 2001
(86) PCT No.: PCT/GR01/00002

(30) Foreign Application Priority Data
Jan. 14, 2000 (GR) 20000100008

(51) Int. Cl. H01F 27/24

(52) U.S. Cl. 336/213

(57) ABSTRACT

This invention refers to the technical field of electricity. The said transformer caters for present deficiencies of variable transformers, regarding the size of the voltage supplied and its accuracy. The accuracy of the voltage supplied of the modern variable transformers presented gaps usually in the order of 0.5-1.5 V (or higher), whereas the voltage supplied is in the order of 120-130% of the used voltage. The referred variable transformer provides absolutely continuous voltage (without gaps), of any value. Furthermore, if features the advantage, that the intensity supplied to be maintained steady throughout the duration of the supply, for any change of the value of the voltage supplied. The above are achieved, by the exact word, of absolute control of the magnetic flow. Constructively it consists of three half cores core-type (see drawing 1, 2 and 4). From these three half cores, the two (B and T) appear characteristic schematic peculiarity, forming between the arch (K), whereas the third (A) may be displaced onto them by the use of suitable mechanism. The variable transformer may be constructed and with a core the type of cylinder too or with similar forms of cylinder (see drawing 3—FIG. (c)). The variable transformer may be constructed as a single or multiphase one for any power.

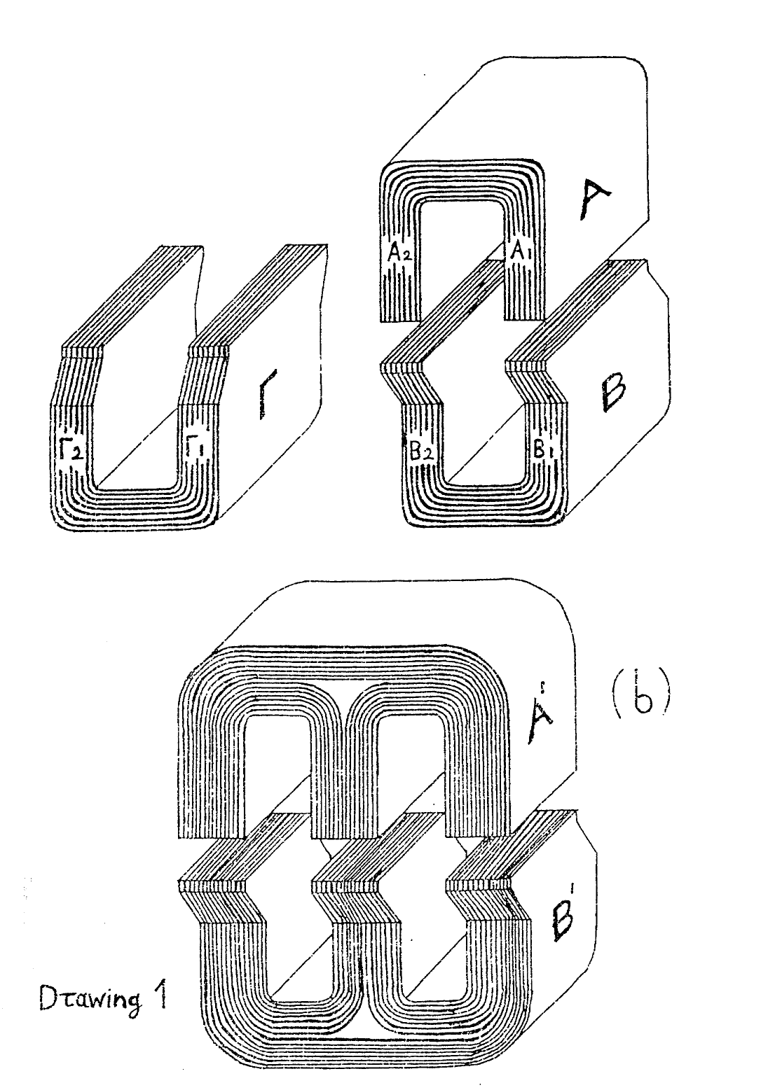

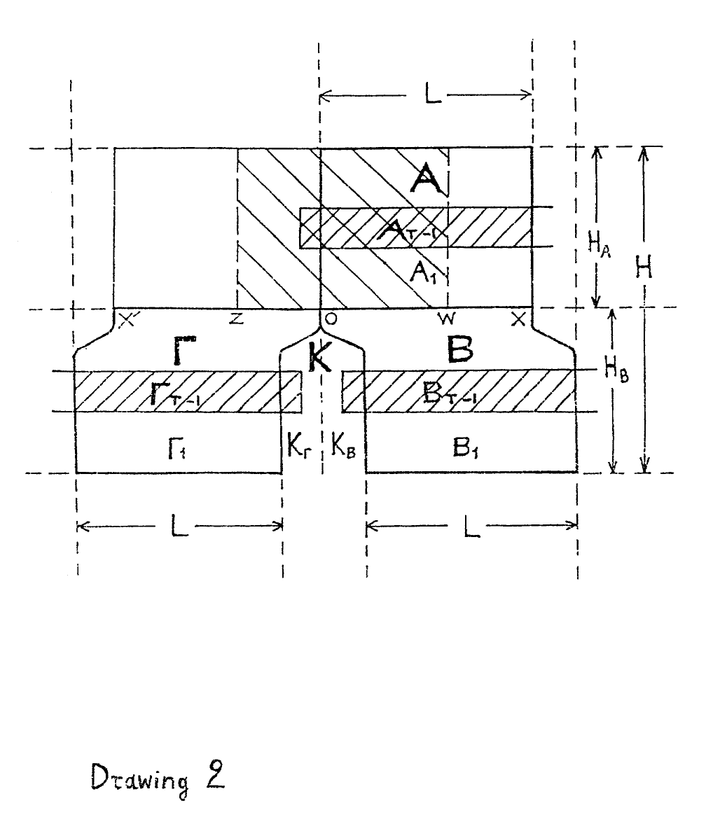

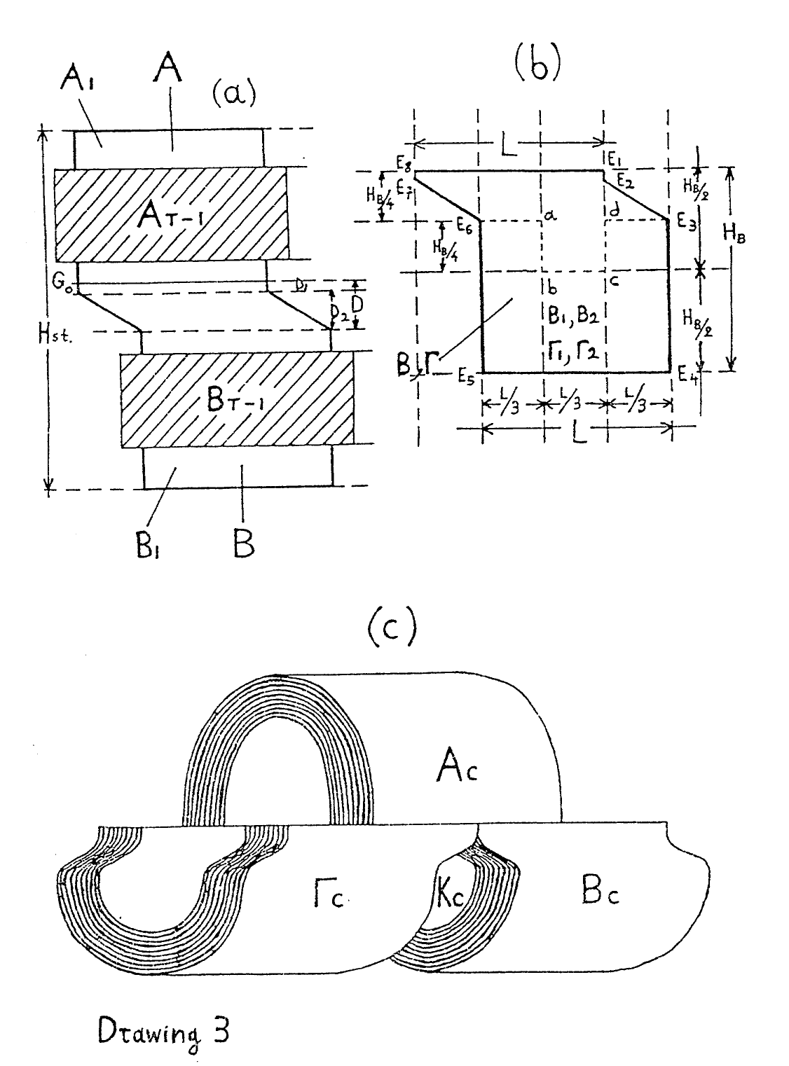

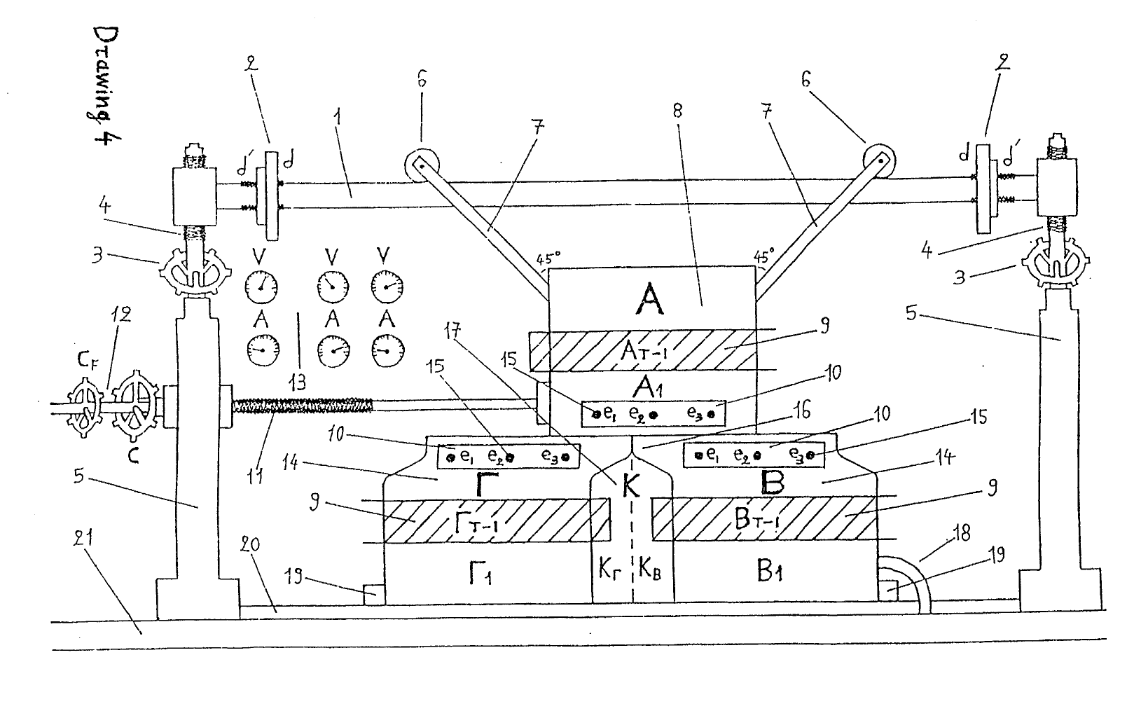

The invention refers to the technical field of electricity.

It concerns a variable transformer through which absolute continuous output voltage is achieved (without any gaps-voids) and the output voltage (the given voltage) can be any (according of course to the relative calculation), changed on will independenly on the value of the input voltage. Furthermore, it has the advantage the given current intesity maintains steady during the supply, for any nominal value of the voltage supplied.

State-of-the-art in this field concerns variable transformers (mainly autotransformers) of the Variac type and of the same types, which have the disadvantages, that the supplied output voltage is not continuous, exhibiting gaps usually in the order of 0.5 to 1.5 V and higher and the voltage supply is very limited in the range of 120-130% of the input voltage, the intensity of the current to be variable, depending on the value of the voltage supplied.

The present invention comes to cater for these deficiencies. In detail, it concerns, a variable power transformer, single-phase, two-phase, three-phase and in general poly-phase, of any voltage supply, of steady intensity and absolute accuracy. (see drawing 1—FIG. (a) and (b) and drawing 2).

This transformer mainly consists of three half nuclei of the core-type, the A, B, and, Γ, which will be hereinafter called simply cores. Of these three cores B and Γ are totally the same, have characteristic schematic peculiarity and form a arch between them. (see drawing I—FIG. (a) and drawing 2—K)). The core A is seated upon and touches well onto the continuous surface consisting of the legs of cores B and Γ and through a suitable mechanism may be drawn (displace, slide) onto the whole surface formed by B and Γ (see drawing 2).

More simple and more analytical, the two legs of core A may, through a suitable mechanism, slide onto the four surfaces of the four legs of the continual cores B and Γ.

Onto one leg of core A the winding of the primary is wound round (it is recommended for reasons of minimizing the volume of the windings, both legs of A to be used viz. two windings, one for each leg, connected in series). Onto the legs of the core B the winding of the secondary is wound round. Similarly onto the legs of core Γ (core Γ is the other secondary). The arch K (see drawing 2) consisting of the empty spaces K_{B} and Kᵣ, is used for the windings both of the core B the K_{B} and of the core Γ the Kᵣ.

The core A (the primary) always touches to B and Γ or B alone or Γ alone. The last two are the terminal positions of A. This implies that A, in any position it is found on B and Γ (of the path X′OX), always constitutes along with the respective part of B and Γ the same, normal core core-type and with the obligatory consequence the magnetic flow, as a flow always of the similar magnetic circuits, is the same, constant and unchanged.

Note. For better understanding of drawing 2, it must be noted that: A, B and Γ are half cores, type of core-type. A₁, A₂ are the legs of A. B₁, B₂ are the legs of B and Γ₁, Γ₂ are the legs of Γ. The core A has the windings, A_{T-1}, on its leg A₁ and A_{T-2} onto its leg A₂. The core B has the windings B_{T-1} and B_{T-2} respectively onto its legs B₁ and B₂. And core Γ has the windings Γ_{T-1} and Γ_{T-2} respectively onto its legs Γ₁ και Γ₂. Due to the side view illustrated in the drawing, the A₂, A_{T-2}, B₂, B_{T-2} and Γ₂, Γ_{T-2} are not visible.

The cores B and Γ (see drawing I—FIG (α)) form the arch K (see drawing 2).

It is obvious that whatever concerns each leg of the cores A, B and Γ also happen and are valid for their other leg. Consequently, when we refer to A₁, B₁, Γ₁, we respectively conclude and the A₂, B₂, Γ₂.

### FUNCTIONAL ANATOMY of the Variable Transformer

Positions of the Core A (see drawing 2)

1rst Position—Marginal Position.

In this position (OX), the A seats exclusively and exactly onto B. The magnetic circuit is achieved exclusively through A and B (The Γ does not participate at all). In this position, any description, analysis and any comment is superfluous, and this, as in this position we have the case of an absolutely normal core-type transformer.

The voltage supplied is the maximum from the winding B_{T-1}.

2^{nd} Position—Random Position

Let A is found in the random ZOW position. It is obvious, that in this random position, the caused magnetic flow from the primary A will pass wholy to its respective ZOW surface of B and Γ, through which will close the magnetic circuit. That means, that the part ZOW and only this will be the functional surface of the surface X′OX (X′OX the two consecutive cross-sections of cores B and Γ). In more detail, the magnetic flow from A will pass at an analogy to the parts OW and OZ. If L is the length of A, the analogy of the flow that B will receive will be exactly OW/L and OZ/L the analogy of the flow that Γ will receive. It is OW+OZ/L=1 the whole from the A the emanating flow.

It is known, that in any core the magnetic flow passing through its cross section is uniformly distributed onto it.

It is obvious, that whatever referred to each leg of the cores A, B and Γ happen and hold and for their other leg.

Consequently, the magnetic flow, that will pass through each of the cores B and Γ, will be analogous dependence of the functional operating surface of B and Γ relatively to the overall flow (viz. of the part of its cross section, that B or Γ <<will offer>> to the flow). If for example ½ of the surface of B (½ of the cross section S_{B}) <<sees>> the surface of A (cross section S_{A}), from B will pass ½ of the overall flow. If it is the ⅓, then ⅓ of the whole flow will pass through, and if 1/v (where v any positive integer or decimal number), 1/v of the whole flow will pass through.

### VOLTAGE OF THE CURRENT

We consider the fundamental known relationship of the transformers:

$$N = \frac{V {.10}^{8}}{4.44 \cdot f \cdot {B}_{max} \cdot S} \qquad ( a )$$

Where,

N=the number of turns of the primary.

V=the voltage in Volts (V) of the primary.

f=the frequency in Hertz (Hz).

Bₘₐₓ=the maximum magnetic flow in Gauss (Gs)

S=the cross section (net) of the core in cm².

Due to the insulations of the sheets of the core, its active mass is demoted (the formula refers to the net core mass) and thus in the denominator of formula (a) a correction coefficient is set equal to 0.9. After this from the formula (a) we receive

$$\frac{N}{V} = \frac{{10}^{8}}{4.44 \cdot 0.9 \cdot f \cdot {B}_{max} \cdot S} \qquad ( b )$$

Note. The corrective coefficient 0.9 in older constructions fluctuated around 0.86-0.87. On its march to reach unity, now it has reached 0.92-0.95. Improvement further than to day's is a direct dependence of progress of the modern technology in the sector of the insulations.

Formula (b) gives us the basic element of transformers, the number of turns per volt of the primary. This number could be extended to the secondary too in the case of an ideal transformer (with no losses).

However, since, ideal transformer doesn't exist, so in order to express the number of turns per Volt of the secontary, the formula (b) is formulated in the following:

$$\frac{{N}_{c}}{{V}_{c} } = \frac{N}{V} \cdot \frac{1}{\sqrt{η}} = \frac{{10}^{8}}{4.44 \cdot 0.9 \cdot f \cdot {B}_{max} \cdot S} \cdot \frac{1}{\sqrt{η}} \qquad ( c )$$

where,

N_{c}=the number of turns of the secondary

V_{c}=the voltage in volts of the secondary

n=the degree (coefficient) of the efficiency of the transformer.

By observing formula (c), we ascertain that its only variable element (in this case) is the cross section S relatively to the cores B and Γ.

As the primary A, in any position of the path X′OX (see drawing 2) always consists along with the respective part of B and Γ a normal core-type core, its voltage is independent on its desplacements. However, regarding cores B and Γ, the voltage supplied by them depends on the position of A on them. Because the magnetic flow that will pass through each of the cores B and Γ, is exclusively dependent on the position of A on B and on Γ. Since the operating cross section of the cores B and Γ changes (change of S in formula (c)), due to the displacements of A, the magnetic flow passing through B and Γ will be changed in proportion. However, the number of the turns of B and Γ is a constant number and the voltage supplied by B and Γ will have the obligatory consequence to change, depending every time on the position of A on them.

Hence, the voltage supplied by B will be the maximum, when A seats exactly onto B, following a waning march as A is displaced towards Γ, to reach zero value, when A seats exactly on Γ. The same holds exactly for core Γ,

The above can be summarised as: The voltage supplied at each time by B and Γ, is exact and analogical dependance on operating cross section each time of cores B and Γ. Example. If the secondary of B, the B_{T-1} (winding), was calculated to supply 1000V with perfect matching of the cross sections of B and A, then B accepts the whole flow from A, if A is displaced towards Γ by ½ of the path Ox, then B will be accepting ½ of the flow (the other ½ will be accepted by Γ). The turns however of B_{T-1} are a constant number and will necessarily provide half of the voltage (V/2), 1000/2=500V. If A is displaced to a random position WZ, the B will be accepting WO/WZ of the overall flow and for our example, the voltage supplied by B will be: WO/WZ·1000 Volts. The same rationale concerns core Γ too.

Taking all the above into consideration, it is concluded, that the voltage supplied by the variable transformer is, in exact words, absolutely continuous and of absolute accuracy, because, in exact words, the control of the magnetic flow is absolutely continuous and absolutely accurate.

3^{rd} Position—Marginal Position

In this position (OX′), the A seats exclusively and exactly onto Γ. The magnetic circuit is achieved exclusively through A and Γ (the B does not participate at all). In this position—like and in the 1rst position—we have and again the case of an completely normal core-type transformer.

The voltage supplied is the maximum from the winding Γ_{T-1}.

Intensity of the Current

The uniformly distribution of the magnetic flow to the cross section of the core, implies and means and uniform distribution of the power of the transformer in its cross section. The power of the transformer is emanation of the magnetic flow.

The power of the transformer, determined from the S² of its cross section S, is a constant magnitute—for S is constant—implying that each core has its own power, which is steady. In this concrete case of the variable transformer, its power in any displacement of A on B and Γ is always steady. This is because, in any place of A on B and Γ on the path X′Ox, we always have a fully normal tranformer, the same transformer (same cross section S).

However, this same power (we refer to the same core always), is separated into B and Γ depending on the position of A onto them. For this reason, it is evident that each part of the cross section of the cores B and Γ, will have a power determined by the ratio of the surface of the part under consideration to the overall surface of the cross section multiplied by the power expressed by the cross section of the core. To wit, if S is the cross section of the core, Sᵥ one part of its cross section, Pᵥ the power of this part and Pₛ the power of the core, then the relationship: Pᵥ=Sᵥ/S·Pₛ holds.

### EXAMPLE

If have power of the core, Pₛ=10,000 VA, this means S=112.4 cm² (S=1.124·\sqrt{Pₛ}), Sᵥ=28.1 cm², then we receive, Pᵥ=28.1/112.4. 10.000=2,500 VA, which will be the power for the part considered of our example.

Note. The coefficient 1.124 is not constant. It is formed by the influence of many factors, among which dominate, the quality of the sheets of the core and the thickness of their insulation. See writing of Dott. Ing. Giorgio Crisci: Costruzione e Calcolo dei Trasformatori, 4^{th} edition S.T.E.M—Modena., pages 25, 26, 27.

After all the above, we are led to the definite expression that: The power supplied each time by the secondary is equal to the product of the power of the core multiplied by the each time ratio of the operating cross section to the overall cross section of the core.

Thus, we come to the understanding that: both the each time voltage supplied and the each time supplied power of the secondaries (B and Γ) is accurate and proportionally dependence of the each time operating cross section of the cores B and Γ.

We consider the formula which provides the intensity of the current to the secondary (B or Γ), is: I₂=Ps₂V₂ where, Ps₂=is the supplied (useful) power, V₂=the voltage supplied by the secondary and I₂=the intensity supplied by the secondary.

By examining the fraction Pₛ₂/V₂, we perceive that the numerator and the denominator of the fraction have a common fate, depending exclusively and only, from the operating cross section of the core (B or Γ). This implies they alterate (viz, increase or decrease) simultaneously in the very same factor, due to the common acceptance by them, of the alterations of the magnetic flow. Thus, P_{S2}/V₂=is constant. Consequence of the common alteration (increases or decreases) numerator and denominator of the fraction P_{S2}/V₂, is that the current intensity provided by the secondary is always constant.

Termination. The variable transformer is of absolute accuracy as for to the voltage supplied, which is continual (with no gaps). The voltage supplied may be any based on the respective calculations and may be alterated at will.

The supplied intensity (both by the winding B_{T-1}, and the winding Γ_{T-1}) is constant throughout the duration of the supply.

Observations

Observation a′. If for several reasons (laboratory, experimental, scientific calculations, practical needs etc.) it is desired to receive various intensities (it is implied that the range of this variety of the intensities is limited), to the secondaries B and Γ, we may have more than one windings.

Thus, if for example we have power of the secondaries P_{SB}=P_{ST}=12,000 VA, we may—indicatively refer—have windings such as:

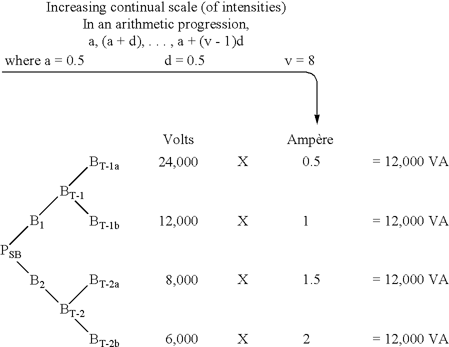

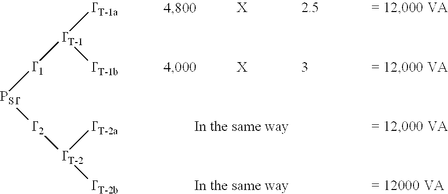

Where the leg B₁ of the core B, instead of one winding B_{T-1}, has two windings, the B_{T-1a} and B_{T-1b}. The similar holds for the leg B₂ of B. And in the same way for legs Γ₁ and Γ₂ of the core Γ.

Relatively to the receipt (use) of the currents, which are steady throughout the duration of the supply, it is superfluous to state that we cannot, get (use) from each of the cores B and Γ but only one current. However, we may use at the same time one current from B and one from Γ. Note. It is self-evident, that a <<free scale>> can be used too, where intensities are calculated according to foreseeing needs.

Observation b′. For achieving a higher variety of intensities, that will interest us for the reasons stated in the observation a′, we face the subject by limiting the power supplied by the transformer.

Thus, if we have useful power of the transformer e.g. 12,000 VA, as in the example of the first observation, then by limiting the supplied power e.g. to 4,000 VA, the following windings may be achieved:

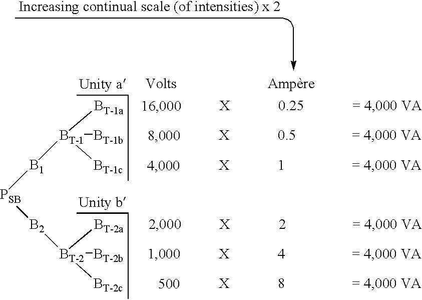

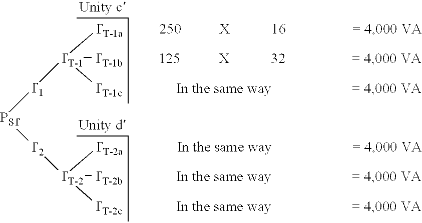

Can be used the following simultaneously:

a) All the currents of unity a′ or unity b′. And only these.

b) All the currents of unity c′ or unity d′. And only these.

c) The combinations of the unities, referring to the simultaneous use of the currents, are the following:

Combinations of Unities

1) Unity a′←with→Unity c′

2) Unity a′←with→Unity d′

3) Unity b′←with→Unity c′

4) Unity b′←with→Unity d′

So, we may use each time at the same time, from one to six intensities, according to the above combinations of unities. The intensities are steady throughout the supply.

The best constractional face of the subject we have, when the relationship of the legs A₁ and B₁, is such, that the height H_{A} of the leg A₁ (see drawing 2) to have the lowest possible value, marginal value, with respect to its winding, in favour of H_{B} (is of course, B₁=B₂=Γ₁=Γ₂).

The total volume of the windings in each of the legs B₁, B₂, Γ₁ and Γ₂ will slightly increase, due to additional insulations.

Note. It is self-evident, that <<a free scale>> can be used too, where intensities are calculated according to foreseeing needs.

In the above development of the subject, other functional or not elements of the transformer, were not referred on purpose, such as, the growth Foucault eddy currents, magnetisation current, losses due to hysteresis, scattering, Joule losses, insulations, and others, as they don't have meaning to the reasoning of the sumject developed.

### Special Relationship of the Legs of the Cores A,B,Γ(Size of Windings Relatively to the Height of the Legs)

The subject is of importance when it concerns large windings, which cause space problems. Handling it is imperative mostly, when one of the three windings (the A_{T-1}, or B_{T-1} or Γ_{T-1}) is calculated to surpass the half of the total useful height of the whole core (the H_{ST}. is considered as a given, inviolable height, (see drawing 3—FIG. (a)).

If the problem is located in, A_{T-1}, then from the height of the core B we subtract the height of the B_{T-1}, the thickness of the core, the internal add-ons (blades for tying of the yoke B on the base, covering of the blades etc.), the height D, a remaining space (indispensably) and the remaining height is in favour of core A, the winding of which appeared (caused) the dimensions problem. In the cutting, viz, of the core core-type, the legs of the A (A₁, A₂) will have the advantage compared with those of B, in the difference of the total sum of the above elements from the height G₀ where the cutting would be effected, in case there was no problem in A_{T-1}, (see drawing 3—FIG. (a)).

It is understood that this correlation of the legs of the A and B will necessarily carry along with Γ too, the legs of which must have the same height with those of B. We act in the same way if the problem is in B_{T-1} or Γ_{T-1}.

Of course the subject is studied in correlation to the cores A,B and Γ.

### Cuttings of B1, B₂ and Γ₁, Γ₂

In Drawing 3—FIG. (b) the cutting E₆abcdE₃ is illustrated, (the same for B₁, B₂ and Γ₁, Γ₂). The cutting is performed for entering the windings in the legs of the cores.

The shown cuffing E₆abcdE₃, doesn't exclude any other, which for the concrete construction should be deemed practically necessary.

### Friction of the Core A with Cores B and Γ

The formula providing the friction is

T=P·η (1)

where, T=the friction, P=the pressure and η=the friction coefficient.

For the metals the friction coefficient varies between 0.15 and 0.5 (by using lubricants, such as, fat, oil, talk, etc, the coefficient may be reduced to 0.005, because the above materials fill the deficiencies of the contracting surfaces).

If the body moves on a horizontal plane (the case of core A), then the vertical force P is equal to the weight of the body B (in this case of the weight of the core A) and the formula (I) becomes:

T=B·η (2),

where B is the weight of the core A.

In the case of steel on to steel, the coefficient of the friction due to sliding for small speeds is: η=0.18 (low sliding speed V≦6^{m}/1″). The friction coefficient due to sliding of metal on metal is: Static friction η=0.19 and Dynamic friction η′=0.18.

For the core A, the value of η estimated inclines towards the static friction. (We think the value: 0.19≧η≧0.1896 is appropriate).

Observation. Special care is recommended regarding the mechanism for controlling friction (of the rubbing surfaces of cores A,B, and Γ, see construction of transformer). In heavy mostly constructions, inefficient control of friction will result to difficulties in the displace of the primary and eventually the possible appearance of phenomena of the deformation of the cores.

### Sensitivity of the Variable Transformer

The sensitivity of the variable transformer depends on the value of the maximum voltage supplied and on the length of the path of the primary A.

The displacement of the primary A is recommended for practical reasons, to be affected by a twin movement system (combination of sprockets, see drawing 4—n. 12).

Two hand operated cranks. One is used for the relatively fast displacement of the primary and one for the relatively slowest (fine control). In this manner the control of the voltage supplied is excellent.

### Cooling of the Variable Transformer

The selection of the appropriate cooling way of the variable transformer, whether natural or artificial cooling with air or natural or artificial cooling by mineral oil are used (these four ways of cooling are the most usual ways), this will depend mainly on the power of the transformer.

For the case of the natural or artificial cooling of the mineral oil of the transformer, the mineral oil used must meet with the following specifications:

1) To be clear, of a clean colour and should not contain suspensions (such as dust, threads, rust etc).

2) To be in excellent insulating tenacity.

3) The specific gravity of the oil at 15° C. not to exceed 0,92 (mineral oils of a low specific gravity are preferred).

4) The ignition point to be very high, in excess of 150° C.

5) Acidity to be less than 0.02% in sulphuric acid (H₂ SO₄).

6) The maximum content in sulphur (S) to be inferior than 0.25%.

7) Freezing point lower than −5° C.

8) Not to contain any alkalis.

9) To be of asphalt and resin-free.

10) The colloid of the mineral oil to be lower 8 degrees Engler at 20° C. and 2.5 degrees Engler at 50° C.

11) It is easily understood, to abide to any other relative obligation deriving from the modern chemistry.

### Technical Proposals—Recommendations

1) The shape of the core (core core-type) can take and others similar forms or almost the same resembling ones, like cylindrical (drawing 3—FIG. (c), core, cylindrical-type) or like cylinder with the characteristic arch in its middle.

2) The sheets which constitute the core, must have an arrangement in the sense illustrated in drawing 3—(c).

3) Special attention must be paid on what concerns in the handling of the manually operated crank for controlling friction (see Drawing 4—n. 3).

4) The secondary windings of the cores B and Γ may be more than one for each core. This is important, as various intensities are received, which as explained, are steady throughout the duration of the supply.

5) The cutting of the core in the middle, which results in two similar half cores, is not always necessary. The cutting can be effected in another location than the middle of the legs of the core, if this is practically served (see special relation of the legs of the cores, A,B,Γ).

6) For transformers of large power, we propose the displacement of the core A through an electronic mechanism.

### Construction of the Variable Transformer

The construction of the variable transformer is basically made, as if it concerns a normal static transformer, of respective power.

It is thus essentially subject to the same specifications, calculations and technical limitations. Its characteristic basic difference, is the peculiarity of the legs of the cores B and Γ and that these legs form an arch between them. Furthermore, is the ability of displacement one of its cores, of A, onto the others B and Γ.

The constructive confrontation of the single-phase variable transformer, clearly emerges from its description and the drawings 2 and 4 (similar is the construction of the three and generally multi-phase variable transformer).

It is added, that for small power transformers, the two cores B and Γ are rigidly fitted on a base. The yokes of B and Γ, are established onto the base, whereas core A is displaced by a suitable mechanism within two special elastic blades, touching the external surfaces of the legs of A₁ and A₂. If the transformer for reasons of safer operation is adopted into a box, the existence above of the core A of a special elastic blade of an analogous width, this would result to perfect contact and displacement of the core A along with and onto of B and Γ. For transformers of higher power capacity, for the safer displacement of the core A, instead of the two special elastic blades two pilot-bars are used, touching the outer surfaces of its legs A₁ and A₂.

Finally, for a single-phase variable transformer of a high power, an indicative construction presentation is given in Drawing 4, where,

1) Iron rail (from which the two arms of A depend).

2) Nuts of terminal displacement of the arms of A (d=main nut and d′=contra-nut. The rolling limits of the wheels no. 6. For the displacement of the nuts the threads are effected onto the edges of the iron rail).

3) Hand-held crank for controlling friction (of the cores A, B, Γ).

4) Height screw (for the adjustment of the height of the iron rail).

5) Concrete column.

6) Wheels.

7) Arms for the support of A.

8) Displaceable core A

9) Windings.

10) Rectangular laminas for achieving the security of the stability of the sheets of the legs A₁, B₁, Γ₁ (The other three laminas in the respective sides of the legs. Similarly for the legs A₂, B₂, Γ₂).

11) Screw for displacing of the core A (the screw is adapted in its base onto a common tie-beam of the legs A₁ and A₂ of A).

12) Manually operated cranks for controlling the voltage C and C_{F} (C_{F}: is for the fine control. The core A may be displaced and by an electronic mechanism).

13) Instruments for controlling the voltage and intensity of the current.

14) Fixed cores B and Γ (The B and Γ constitute the basis of the variable transformer).

15) Screws (the screws e₁, e₂, and e₃ of each lamina not to constitute closed turns with the respective lamina of the opposite sides).

16) Joint of cores B and Γ.

17) Arch (from the cores B and Γ).

18) Grounding. (For the importance and the technique concerning groundings in transformers, see: The J & P Transformer Book

NEWNES—BUTTER WORTHS

LONDON-BOSTON 10^{th} edition, pages 448 and on.

19) Ground prominences (for achieving stability of the cores B and Γ)

20) Carpet of high thermal tenacity or non-combustible.

21) Ground.

The three-phase variable transformer is constructed in the same manner. Respectively for the single-phase one, we have three cores (half cores) in the three-phase one, the A′, B′ and F′ (see drawing 1—FIG. (b)). The core Γ′ is the same as the core B′. In the single-phase transformer the two legs of the mobile core A are displaced, whereas in the three-phase one the three legs of the mobile core A′ are displaced.

The variable transformer may be constructed and with a type of cylindrical core too (see drawing 3—FIG. (c)). The arrangement of the sheets of its core, in the sense shown in the FIG.), either as a single-phase or as multi-phase one. In this case everything is faced, as in the case of a variable transformer core core-type, as already discussed.

The construction of a two-phase, three-phase and in general multi-phase variable transformer doesn't have any essential difference in its general lines from the single-phase variable transformer.

Referring, for example, to the three phase variable transformer, we have two methods of its construction.

Method a′

We install three single-phase variable transformers, the a, b, c, exactly the same, the cores of which compose the system,

| | | |
|---|---|---|
| aB_{B1-B2} | bB_{B1-B2} | cB_{B1-B2} |
| aA_{A1-A2} | bA_{A1-A2} | cA_{A1-A2} |
| aΓ_{Γ1-Γ2} | bΓ_{Γ1-Γ2} | cΓ_{Γ1-Γ2} |

(A_{A1-A2}, the core A with its legs A₁, A₂. Similarly the cores B and Γ) one by the side of the other (parallel arrangement) or one in front of the other (longitudinal arrangement). The yokes of the mobile cores (viz of the primaries) are stably connected between them (block) and with a suitable mechanism (according to the referred for the single-phase variable transformer) we have a common and synchronous displacement of them.

More simply, the a A_{A1-A2}, bA_{A1-A2}, and cA_{A1-A2}, are stably connected between them and consequently displace all together and simultaneously, onto the corresponding (aB_{B1-B2}, aΓᵣ₁₋ᵣ₂)

(Wa), (bB_{B1-B2}, bΓᵣ₁₋ᵣ₂) (Wb), and (cB_{B1-B2}, c{cube root}ᵣ₁₋ᵣ₂) (Wc), however, this means common and synchronous increase and decrease of the magnetic flows that the (Wa), (W_{b}) and (W_{c}) receive. For the consequences of these increases and decreases see operation of the single-phase transformer.

As for the connection of the windings of the three-phase transformer, the prevailing view with respect to the selection of the way of the connection lies in the kind of the consumer or in the peculiarities of the network that the transformer will supply.

Usual connection is, the three windings of the primary H.V. (high voltage) connected per triangle and the three windings of the secondary L.V. (low voltage) connected per star.

Relativelly to the proper ways of connection, see writing M. Kostenko and L. Piotrovsky, Electrical Machines. MIR Publications—Moscow, english translation from Russian by A. Chernukhin, volume I page 428 to 439.

Method b′

The core of the three-phase transformer is like that of the single-phase one mentioned, with the difference that it has three legs (it is obligatory that the arrangement of the sheets of the cores of the three-phase transformer to be in the sence shown in the drawing 1—FIG. (b)).

The halves of these three legs displace (slide) onto the respective six half-legs, in the very same way like in the single-phase variable transformer. The displacement is achieved through a suitable mechanism, which in this case is attached to the common by construction yoke of the three legs or to the two extremes legs. As for the rest, reference is made to the method a′ and the operation of the single-phase variable transformer.

In the same methods an v-phase transformer is constructed (where v is positive integer number).

During the construction of any transformer, the recommendations of the specialist must be followed and applied constructional perceptions, derived from industrial practice. Anything further belongs to research.

1. Variable power transformer, of any voltage supply, steady current intensity and absolute accuracy.
The variable transformer provides output voltage of any value (according of course to the relative calculation), changed at will independently on the value of the input voltage, absolute continuous (with no gaps-voids) and of absolute exactness. The given current intensity is steady during the supply, independently on the wishing changes of the value of the voltage.
Its core, core-type or cylinder-type consists of three half-cores, the two of which (B and Γ or Bc and Γc) characterised by their peculiar shape, forming between them a arch (K or Kc), whereas the third (A or Ac) may be displaced on them.

2. The variable transformer of claim 1, can be manufactured as single-phase, two-phase, three-phase or in general v-phase (where v a positive integer number), with a core core-type or cylinder-type or similar cylinder types.

3. The mobile core (A or Ac) of the referred claims 1 and 2 of the variable transformer, may be displaced (slide) through a manual or electronic mechanism.

4. The referred to 1,2 and 3 claims variable transformer may be manufactured for any power.
